(19) United States
(12) Patent Application Publication
(10) Pub. No.: US 2009/0035547 A1
(43) Pub. Date: Feb. 5, 2009

(54) Spinning device of a textile machine

(75) Inventors: Dieter Haaken, Erkelenz (DE); Gottfried Schurmann, Schinveld (DE); Heinz-Georg Wassenhoven, Monchengladbach (DE)

Correspondence Address: K&L Gates LLP, 214 N. TRYON STREET, HEARST TOWER, 47TH FLOOR, CHARLOTTE, NC, 28202, US

(73) Assignee: Oerlikon Textile GmbH & Co. KG, Monchengladbach (DE)

(21) Appl. No.: 12/221,506

(22) Filed: Aug. 4, 2008

(30) Foreign Application Priority Data
Aug. 4, 2007 (DE) 10 2007 036 927.3

(51) Int. Cl. B32B 5/02; D01H 4/00

(52) U.S. Cl. 428/220; 428/426; 428/325; 57/408

(57) ABSTRACT

A spinning device (1, 10) of a textile machine provided with a multi-layer coating, wherein the surfaces (4, 20) which are subjected to wear by contact with fiber material are coated with a hard material body-containing dispersion layer made of a nonferrous metal including hard material bodies comprised of ceramic particles (8), wherein the ceramic particles (8) have a rounded surface.

### CROSS-REFERENCE TO RELATED APPLICATIONS

This application claims the benefit of German patent application 10 2007 036 927.3 filed Aug. 4, 2007, herein incorporated by reference.

### BACKGROUND OF THE INVENTION

The present invention relates to a spinning device of a textile machine and, more particularly, to such a spinning device wherein the surfaces which are subject to wearing by contact with fiber material are coated with a hard material body-containing dispersion layer made of a nonferrous metal including hard material bodies comprised of ceramic particles.

A spinning rotor for an open-end rotor spinning machine is known from German Patent Publication DE 33 39 852 A1, the surface regions of which come into contact with a fiber material are provided with a coating. The spinning rotor comprises a rotor cup with a fiber collecting groove and a fiber slide face. The rotor cup is provided, on the inside, with an abrasion-resistant coating made of iron boride, on which a hard material body-containing coating made of a nonferrous metal is applied. The hard material bodies are diamond particles or brittle crystals or crystallites made of ceramic. The roughness of the fiber slide face achieved by the hard material body-containing coating is used to orientate the fiber material introduced in the peripheral direction of the spinning rotor to improve the result of the spinning process.

An opening device for an open-end spinning machine is known from German Patent Publication DE 102004029659 A1 and has an at least two-layer structure of the coating of its surface, the outer layer coming into contact with fiber material being a hard material body-containing layer. This layer consists of particularly hard material fractions, which are materials with properties of diamond-like carbon compounds.

It proves to be very disadvantageous in a coating of this type for a spinning device that the surface structure of monocrystalline but also polycrystalline diamond particles or diamond-like carbon compounds used as hard material bodies is very irregular and has sharp edges. As a result, a high degree of roughness of the surface is achieved but these properties of the hard material bodies have a negative effect on the fiber material brought into contact with the spinning device as the fibers are damaged or partially cut, for example while sliding down the coated surface of the spinning rotor, so the quality of the spun thread is impaired.

### SUMMARY OF THE INVENTION

An object of the present invention is to provide a spinning device, by means of which the disadvantages known from the prior art can be reduced.

This is achieved according to the invention in a spinning device of a textile machine provided with a multi-layer coating, wherein the surfaces (4, 20) which are subjected to wear by contact with fiber material are coated with a hard material body-containing dispersion layer made of a nonferrous metal including hard material bodies comprised of ceramic particles. According to the invention, the ceramic particles (8) have a rounded surface.

Advantageous further embodiments, configurations, features and advantages of the invention are described more fully hereinafter.

It is proposed according to the invention that the ceramic particles have a rounded surface. The ceramic particles partially projecting from the nonferrous metal layer on the surface, because of their rounded contour, reduce damage to the fibers supplied to the spinning device as, in contrast to the monocrystalline or polycrystalline diamond particles or polycrystalline ceramics used as hard material bodies in the prior art, they have no sharp-edged portions. The reduction which can be achieved by using rounded ceramic particles in the damage to the fiber material brought into contact with the surfaces of the spinning device has an advantageous effect on the spun yarn quality.

The ceramic particles being used may be ceramics based on oxide, such as, for example, silicon oxide, aluminium oxide, zirconium oxide or beryllium oxide, or non-oxide ceramics based on carbide or nitride, such as, for example, silicon carbide, silicon nitride, aluminium nitride or boron carbide or boron nitride.

Advantageously, the ceramic particles may be spherical. This shape has the advantage of simple production because of its symmetry. In particular, this allows different ceramic particle diameters to be more easily sorted during the production process to be able to more precisely determine the proportion of ceramic particles of different diameter in the dispersion layer.

Ceramic particles having a diameter greater than 6 micrometers have proven to be particularly advantageous. In particular, the ceramic particles may have a diameter of up to 12 micrometers. Compared to the use of hard material bodies with a smaller diameter, as provided in the prior art, the advantage of the ceramic particles according to the invention is that the drawing of the fiber material supplied to the spinning device is promoted. The use of larger ceramic particles improves the picking up and drawing of the fibers supplied to the spinning device without damaging the fibers. When impacting against the coated surface of the spinning device, the fibers do not catch on sharp edges but, rather, are guided by the rounded contour of the ceramic particles according to the invention onto the base of the coating and can expand over their full length. In this case, ceramic particles with different diameters are preferably introduced in different proportions into the dispersion layer. The variation in the respective proportions of ceramic particles inside the dispersion layer means that the coated surface has an irregular roughness. In this manner, the sliding and orientation behaviour of the separated fibers in the spinning device is positively influenced.

The ceramic particles should preferably project by less than 50% of their surface from the coating. In this manner, reliable incorporation of the spherical ceramic particles is achieved, so levering out by means of the fiber material is substantially reduced.

In particular, the nonferrous metal of the dispersion layer may consist of nickel or a nickel alloy.

The dispersion layer may have a thickness of more than 9 micrometers. An upper limit for the thickness of the dispersion layer of 27 micrometers has been found to be technically expedient.

The dispersion layer may preferably have a proportion of ceramic particles of 20 to 35 percent by volume.

In an advantageous development, the spinning device may be a spinning rotor comprising a rotor cup, which has a fiber slide face and a fiber collecting groove, the fiber collecting groove being kept free of hard material bodies. By keeping the fiber collecting groove free, the changing of the surface roughness of the fiber collecting groove during the coating process is avoided, thus producing advantages in terms of spinning technology. By keeping the smooth surface structure of the fiber collecting groove, collection of dirt in the fiber collecting groove, in particular from the fiber residues or dust, is prevented, so the quality and economy of this spinning process can be increased.

During the coating of the spinning rotor an abrasion-resistant surface is formed by boration of at least the fiber slide face and the fiber collecting groove, on which abrasion-resistant surface a nonferrous metal layer is applied after the boration to the fiber slide face and the fiber collecting groove. The fiber collecting groove is then covered by means of an insert and a fiber slide face is coated with a dispersion layer with hard material particles made of ceramic particles which have a rounded contour. The corrosion resistance of the spinning rotor is achieved by applying a nonferrous metal coating to the fiber slide face and the fiber collecting groove. The fiber slide face is then provided with a dispersion coating with hard material particles made of ceramic particles, which have a rounded contour. The surface of the fiber slide face coated in this manner of the spinning rotor according to the invention has a roughness, which is required for orientation of the fiber material on the fiber slide face without the fiber material being subjected to damage by sharp-edged hard material bodies projecting from the dispersion coating. A spinning process which can be carried out at a high processing speed and which results in a qualitatively high-value thread, can thereby be implemented.

Advantageously a cover can be introduced into the spinning rotor, which covers the fiber collecting groove during the application of ceramic particle-containing dispersion layer. This may preferably be a flexible plastics material ring or the like, which is adapted for the contour of the fiber collecting groove to be able to bring the dispersion layer so close to the fiber collecting groove that it terminates with the beginning of the fiber collecting groove. As a result, a more pronounced shaping of the wedge shape of the rotor groove is achieved.

In contrast to the fiber slide face which has an increased roughness to orientate and draw the fibers, the reduced roughness in the fiber collecting groove brings about a reduction in the impurities in the fiber collecting groove due to the depositing of dust, so the outlay for cleaning is reduced.

Furthermore, the spinning device may be an opening roller. Owing to the embodiment of the hard material particles according to the invention as ceramic particles with a rounded contour for coating a clothing wire or clothing ring of the opening roller, the process of subsequent nickel plating, which is imperatively necessary in a diamond particle-containing coating to protect the fiber material being connected to the clothing wire or clothing ring of the opening roller, is dispensed with. In the opening roller, the coating is used for protection against wear, in which damage to the fiber material due to the surface being too rough should also be avoided here during the process of fiber band opening.

### BRIEF DESCRIPTION OF THE DRAWINGS

The invention will be described in more detail below with the aid of embodiments shown in the drawings, in which:

FIG. 1 shows a partial sectional view of a spinning rotor coated according to the invention;

FIG. 2 shows a partial sectional view of an opening roller coated according to the invention;

FIG. 3 shows a schematic view of a greatly enlarged portion of the surface topography of the inside of the rotor cup according to FIG. 1.

### DETAILED DESCRIPTION OF THE PREFERRED EMBODIMENTS

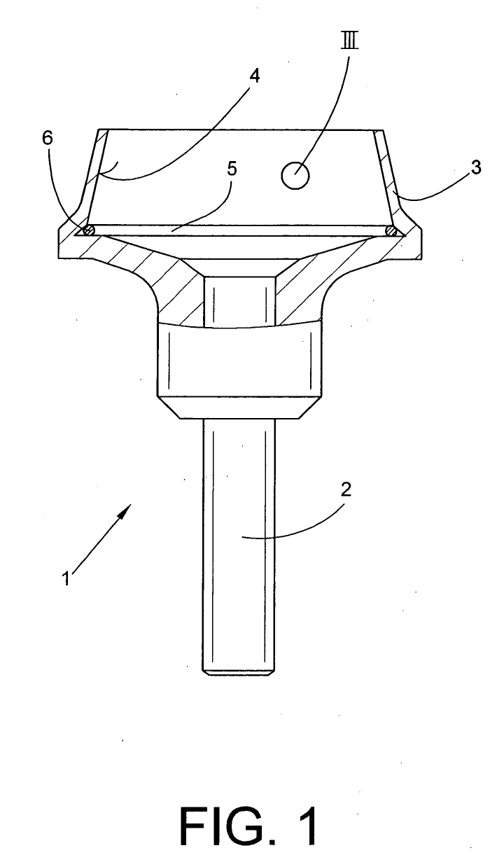

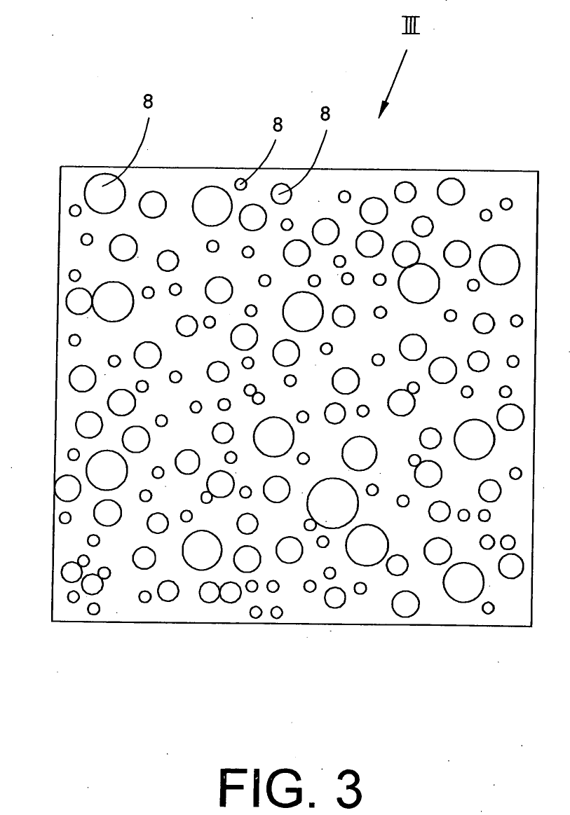

FIG. 1 shows a spinning rotor 1, the rotor cup 3 of which is shown in section in the longitudinal direction. The spinning rotor 1 is preferably produced from tempered steel, and has a rotor shaft 2 and a rotor cup 3. The rotor cup 3, in its interior, has a fiber slide face 4 as well as a fiber collecting groove 5. The surface of the spinning rotor 1 is provided with an abrasion-resistant coating based on boride, which is used for protection of the spinning rotor 1 against wear. A nonferrous metal-containing corrosion-resistant layer, preferably based on a nickel alloy, is applied to the boride layer and preferably forms the basis for a subsequent coating of the fiber slide face 4 with a hard material body-containing dispersion layer 7, the construction and composition of which is illustrated with the aid of FIG. 3.

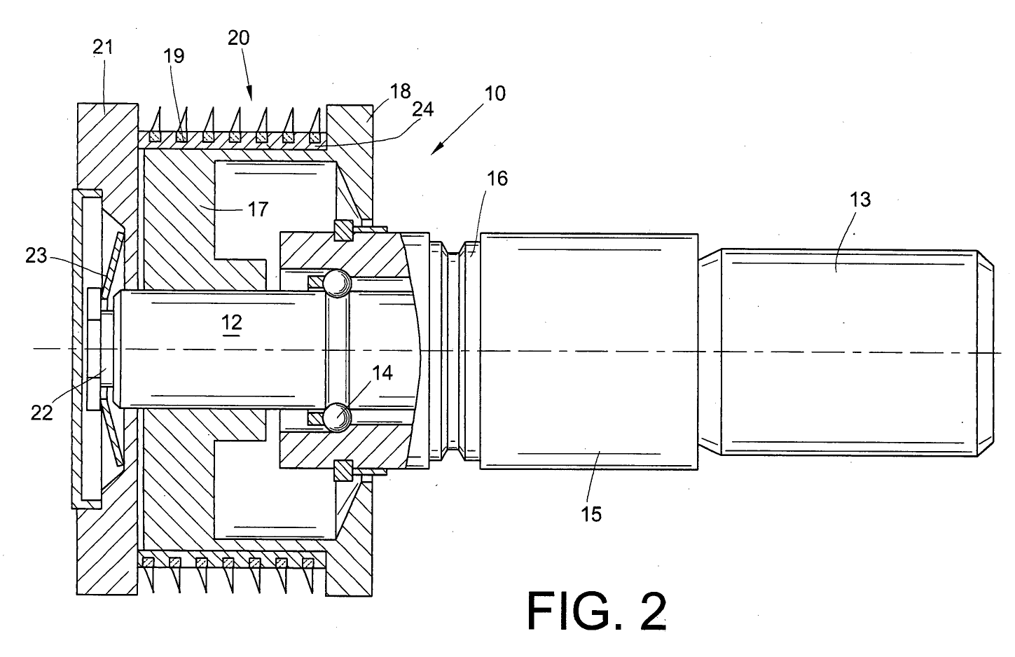

FIG. 2 shows an opening roller 10, which has a bearing shaft 12, on which a so-called drive wharve 13 is fixed at the end. The bearing shaft 12 is rotatably mounted inside a bearing housing 15 by means of roller bearings 14. The bearing housing 15 is in turn fixed in a bearing bracket (not shown) of an opening roller housing and locked there by means of a securing element, which engages tangentially through the plastic material ring 16.

A roller body 17 is arranged at the front on the bearing shaft 12. The roller body 17 is non-rotatably connected to the bearing shaft 12 by means of a press fit. The roller body 17 has a cylindrical shape and at the rear has a flange 18. The surface of the roller body 17 is preferably smooth in this case. At the front, the opening roller 10 has a further flange 21 which, for example, is connected by means of a screw bolt 22 and a compression spring 23, to the bearing shaft 12.

A saw tooth clothing can be fixed directly on the surface of the cylindrical roller body 17, or the saw tooth clothing 20 is fixed indirectly, in other words, mounted on a carrier element 24, as shown in FIG. 2. The front flange 21, in this case, in the fitted state, fixes the saw tooth clothing 20 on the roller body 17.

The saw tooth clothing 20 has a base body shaped in a helical spring-like manner, which may have different cross sectional designs. FIG. 2 shows a saw tooth clothing 20, which, with the windings of its base body, is let into a helically extending groove 19 of the carrier element 24. The saw tooth clothing 20, like the rotor cup 3, is coated with a hard material body-containing dispersion layer 7, the hard material bodies being ceramic particles 8 with a rounded surface. Apart from protection of the fiber material coming into contact with the coated surfaces, as in the spinning rotor 1 as well, the coating is moreover also used for the protection of the spinning device against wear.

FIG. 3 shows a greatly enlarged cut-out of the coated surface of the rotor cup 3 according to FIG. 1, with the aid of which the method for coating and the structure of the coating are illustrated. Prior to the coating with the hard material body-containing dispersion layer 7, a preferably annular cover 6 is introduced into the fiber collecting groove 5, as indicated in FIG. 1, which positively fills the fiber collecting groove 5. The cover 6 may, for example, be an O-ring or an annular insert, which has at least an external contour adapted in portions to the contour of the fiber collecting groove 5. By means of the cover 6 in the fiber collecting groove 5, penetration of the hard material body-containing dispersion, during the coating process, into the fiber collecting groove 5 and this also being coated, is to be avoided.

The hard material body-containing dispersion layer 7 is preferably a dispersion based on a nonferrous metal such as nickel or a nickel alloy, which is enriched with ceramic particles 8 of different diameters. The ceramic particles 8 in this case have a diameter which is greater than 6 micrometers, preferably up to a diameter of 12 micrometers. The ceramic particles 8 introduced into the dispersion layer 7 in this case have a rounded contour which, in contrast to the crystalline structure of the diamond particles or the like used in the prior art as the hard material bodies, ensures an increased surface roughness on the fiber slide face 4, but, on the other hand, reduces damage to the fiber material introduced into the rotor 1. The spinning rotor 1 is coated by sufficiently known coating processes, such as, for example, the PVD method, the CVD method, chemical or electroplating methods. The hard material body-containing dispersion layer 7 applied to the fiber slide face 4 in this case has a thickness of more than 9 micrometers and may be up to 27 micrometers. The dispersion layer 7 comprises a proportion of ceramic particles 8 of 20 to 35 percent by volume.

The surface topography being produced by the coating of the rotor cup 3 is shown in FIG. 3 as a greatly enlarged, schematic view of a surface portion of the fiber slide face 4. The ceramic particles 8, as already stated, have different diameters and do not fall below a minimum diameter of 6 micrometers. The ceramic particles 8 used for the coating of the surface portion shown in FIG. 3 are substantially spherical, so damage to the fiber material introduced into the rotor cup 3 is avoided.

However, geometries which differ from the spherical shape may also be used if the ceramic particles 8 have a rounded contour. For example, the ceramic particles 8 may have the shape of a rotational ellipsoid if the deviations of the semiaxes with respect to one another are not more than 10%. Ceramic particles 8, the contour of which is substantially non-symmetrical but shaped by rounded faces, are also conceivable so as not to forfeit the advantages important to the invention. To ensure a secure hold in the dispersion layer 7, the ceramic particles 8 project by less than 50% of their surface from the dispersion layer 7.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

1. A spinning device (1, 10) of a textile machine provided with a multi-layer coating, wherein the surfaces (4, 20) which are subjected to wear by contact with fiber material are coated with a hard material body-containing dispersion layer made of a nonferrous metal including hard material bodies comprised of ceramic particles (8), characterized in that the ceramic particles (8) have a rounded surface.

2. A spinning device (1, 10) according to claim 1, characterized in that the ceramic particles (8) are spherical.

3. A spinning device (1, 10) according to claim 1, characterized in that the ceramic particles (8) have a diameter which is greater than 6 micrometers.

4. A spinning device (1, 10) according to claim 3, characterized in that the ceramic particles (8) have a diameter of up to 12 micrometers.

5. A spinning device (1, 10) according to claim 1, characterized in that the ceramic particles (8) project by less than 50% of their surface from the coating.

6. A spinning device (1, 10) according to claim 1, characterized in that the nonferrous metal consists of nickel or a nickel alloy.

7. A spinning device (1, 10) according to claim 1, characterized in that the dispersion layer (7) has a thickness of more than 9 micrometers up to 27 micrometers.

8. A spinning device (1, 10) according to claim 1, characterized in that the dispersion layer (7) has a proportion of ceramic particles from 20 to 35 percent by volume.

9. A spinning device (1, 10) according to claim 1, characterized in that the spinning device is a spinning rotor (1), which has a rotor cup (3) with a fiber slide face (4) and a fiber collecting groove (5), the fiber collecting groove (5) of which is kept free of hard material bodies.

10. A spinning device (1, 10) according to claim 1, characterized in that the spinning device is an opening roller (10).
